(19) United States
(12) Patent Application Publication
(10) Pub. No.: US 2025/0010405 A1
(43) Pub. Date: Jan. 9, 2025

(54) LASER MACHINING METHOD, AND LASER MACHINE TOOL

(71) Applicant: TRUMPF Werkzeugmaschinen SE + Co. KG, Ditzingen (DE)

(72) Inventors: Winfried Magg, Ditzingen (DE); Steffen Keßler, Stuttgart (DE); David Schindhelm, Stuttgart (DE); Alexander Schmid, Gärtringen (DE); Christian Keller, Heilbronn (DE)

(21) Appl. No.: 18/889,439

(22) Filed: Sep. 19, 2024

Related U.S. Application Data
(63) Continuation of application No. PCT/EP2023/051859, filed on Jan. 26, 2023.

(30) Foreign Application Priority Data
Mar. 22, 2022 (DE) 10 2022 106 605.3

(51) Int. Cl. B23K 31/10; B23K 26/38

(52) U.S. Cl. CPC B23K 31/10; B23K 26/38

(57) ABSTRACT

A laser machining method includes defining at least one threshold value S₀ with respect to a light-intensity-dependent first process variable F in at least one working range K_{AB} or at a working point K_{AP}, detecting a light-intensity-independent second process variable K during operation of a laser machine tool in the at least one working range K_{AB} or at the working point K_{AP}, determining a change in the first process variable F in the at least one working range K_{AB} or at the working point K_{AP} when process conditions change, and changing the at least one threshold value S₀ to a second threshold value S_{0R} according to the change of the first process variable F from a first value F₀ to a second value F_{0R}.

### CROSS REFERENCE TO RELATED APPLICATIONS

This application is a continuation of International Application No. PCT/EP2023/051859 (WO 2023/179934 A1), filed on Jan. 26, 2023, and claims benefit to German Patent Application No. DE 10 2022 106 605.3, filed on Mar. 22, 2022. The aforementioned applications are hereby incorporated by reference herein.

### FIELD

Embodiments of the present invention relate to a laser machining method, a laser machine tool and a computer-readable medium.

### BACKGROUND

The technical field of industrial machining of various materials using laser radiation is becoming increasingly important. When cutting workpieces made of different materials, for example, use is made of laser radiation from a laser machine tool or laser cutting machine with high power, usually in the range of several kilowatts. To monitor laser machining processes, laser machine tools are assigned sensor devices which measure a variety of measured variables which are evaluated in a control device. An example of a sensor device is a camera, with which light intensities are detected as spatially resolved measurement variables on a machined workpiece. Various conclusions can be drawn from the light intensities regarding the quality of the machining. These conclusions can be used for monitoring and control functions for the laser machine tool. For example, it can be used to detect a cut break during laser cutting. A cut break is a cut that is undesirably not made completely across the entire width of the workpiece. Changes in process conditions can cause a previously calibrated and functional sensor device to malfunction. These changed process conditions can have various causes. Firstly, there are malfunctions or deviations in the laser machine tool, such as a soiled protective glass, heating of the lens system, or a change in the purity of a gas jet. These disturbances or deviations have an impact on the laser machining process or on the detection by the sensor device. Secondly, deviations in the material to be processed, such as the sheet thickness of a workpiece, the surface finish, the material composition, or material inclusions. These deviations can influence the process and process control of laser machining. Thirdly, deviations in the selected process control, such as a changed focus position, a changed focus diameter, changes in the distance from the workpiece to a nozzle at the exit of the laser beam, or a changed gas pressure. This means that existing miscuts are not detected or non-existent miscuts are wrongly detected. One measure in the prior art is a further calibration process of the laser machine tool with a sensor device, which is usually carried out in separate work steps, i.e., outside of the machine running time. For example, it is necessary to recalibrate with regard to the transmission of the process radiation through the optical elements used and the sensor device or due to decreasing sensitivity of the sensor.

### SUMMARY

Embodiments of the present invention provide a laser machining method. The method includes defining at least one threshold value S₀ with respect to a light-intensity-dependent first process variable F in at least one working range K_{AB} or at a working point K_{AP}, detecting a light-intensity-independent second process variable K during operation of a laser machine tool in the at least one working range K_{AB} or at the working point K_{AP}, determining a change in the first process variable F in the at least one working range K_{AB} or at the working point K_{AP} when process conditions change, and changing the at least one threshold value S₀ to a second threshold value S_{0R} according to the change of the first process variable F from a first value F₀ to a second value F_{0R}.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a device for monitoring a laser machining method, in particular a laser cutting process, as part of a laser machine tool by recording an image of a region of the workpiece to be monitored, which contains an interaction region, according to some embodiments;

FIG. 2 shows a schematic representation of a laser machine tool with a further device for monitoring a laser machining process, in particular a laser cutting process, according to some embodiments; and

FIG. 3 shows a qualitative diagram with threshold values S of a first process variable F on the y-axis, a second process variable K on the x-axis, characteristic curves with working ranges and a working point, and a miscut region of the laser machine tool in operation, according to some embodiments.

### DETAILED DESCRIPTION

Embodiments of the invention provide a laser machine tool and a laser machining method as well as a computer-readable medium with which malfunctions are reduced.

According to embodiments of the present invention, a laser machining method is provided with the following method steps.
Defining at least one threshold value S₀ regarding a first light-intensity-dependent process variable F₀ in at least one working range K_{AB} or one working point K_{AP};
Detecting a second, light-intensity-independent process variable K during operation of a laser machine tool (10) in at least one working range K_{AB} or at the working point K_{AP};
Determining a change in the first process variable F₀ in the working range K_{AB} or working point K_{AP} when process conditions change;
Changing at least one threshold value S₀ to a threshold value S_{0R} according to the change of the first process variable F_{0R}.

In addition, a computer program product is provided in an evaluation device for carrying out the laser machining method.

Furthermore, a laser machine tool with an evaluation device is provided, wherein the evaluation device is designed to define at least one threshold value S₀ with respect to a light-intensity-dependent first process variable F in at least one working range K_{AB} or a working point K_{AP}, a light-intensity-independent second process variable K during operation of a laser machine tool in a working range K_{AB} or working point K_{AP} to detect a change in the first process variable F in at least one working range K_{AB} or at the working point K_{AP} under changed process conditions, and to change at least one threshold value S₀ to a threshold value S_{0R} according to the change of the first process variable F from a value F₀ to a value F_{0R}.

In one example, a control setpoint R of the laser machining process is assigned to the threshold value S₀ and the control setpoint R is changed to a control setpoint R_{OR} according to the change of the first process variable F from a value F₀ to a value F_{0R}. If the first process variable F changes, the control setpoint is changed.

In one example in the control method step, the second process variable K is the trailing length or the inclination angle of a cutting front on a workpiece to be cut. The trailing length is the length in the feed direction of the workpiece from the cutting front on the top to the cutting front on the bottom of the workpiece. The inclination angle of the cutting front can be measured from the top to the bottom of the workpiece. These process variables K have proven to be suitable for the functionality, since they can be detected independently of light intensity, hereinafter also intensity-independent.

In another example, the method step of changing the threshold value S₀ to the threshold value S_{0R} is carried out at the working point K_{AP} or in the working range K_{AB} according to a light intensity recorded on the workpiece or a process variable that depends on the light intensity, as the first process variable F.

Based on the changed threshold value S_{0R}, a malfunction of the laser machine tool can be determined or a monitoring or control variable that is less dependent on changes in light intensity can be stabilized. A malfunction with the changed threshold value is advantageous S_{0R} which reflects the actual conditions of the laser machine tool better under changed conditions than the originally defined threshold value S₀. In the context of the present disclosure, the term malfunction also refers to faulty or undesirable machining processes and machining errors.

In one example, a cut break is recognized as a malfunction based on the changed threshold value S_{0R}. The changed threshold value S_{0R} serves to reliably detect a cut break and to prevent incorrect detection of a cut break or non-detection of a cut break with an unchanged threshold value S₀. In the first case, either there is no malfunction but a malfunction is falsely detected. Or, in the second case, a malfunction exists but no malfunction is detected.

Advantageously, it was found that malfunctions of the laser machine tool can be effectively reduced by proportionally changing the threshold value S₀ to the threshold value S_{0R} according to the changed first process variable F.

Furthermore, the threshold value S_{0R} is continuously changed in a control process of the laser machining method. In this way, the threshold value S_{0R} for the light-intensity-dependent first process variable F is adjusted in terms of control technology.

In another example, the control process or the control is carried out with the second process variable K as a control variable, whereby the adjustable variable is a feed rate of the workpiece in the laser machine tool or the power supply of the laser machine tool. Thus, the control variable, the second process variable K, is set by adjusting the specified adjustable variables.

In an example, the threshold value S₀ is continuously or iteratively changed or adjusted. This ensures that the threshold value S₀ always corresponds to the current conditions of the laser machine tool. With this measure, a high level of process stability can be achieved. The first process variable F is detected depending on location and/or direction. The threshold value S₀ can be adjusted accordingly depending on location and/or direction. This allows anisotropies or inhomogeneities of the laser machine tool to be taken into account and compensated within its working range. Alternatively or additionally, the changes in the first process variable F are detected time-dependently and the threshold value S₀ can be adjusted depending on time. When adjusting the threshold value S₀ it can also be taken into account how long ago the information about a cutting location or a cutting direction was available or dates back. If a cut was made in the same cutting direction just a few seconds before, it is more likely that the laser machine tool is still in a similar state, while a cut after a minute or more makes it more likely that the laser machine tool is no longer in the same state. The threshold value S₀ can therefore also be a function of the chronological progression of the available information. Chronological aspects can be taken into account when adjusting the threshold value S₀.

Embodiments of the invention are described in detail below with reference to the figures.

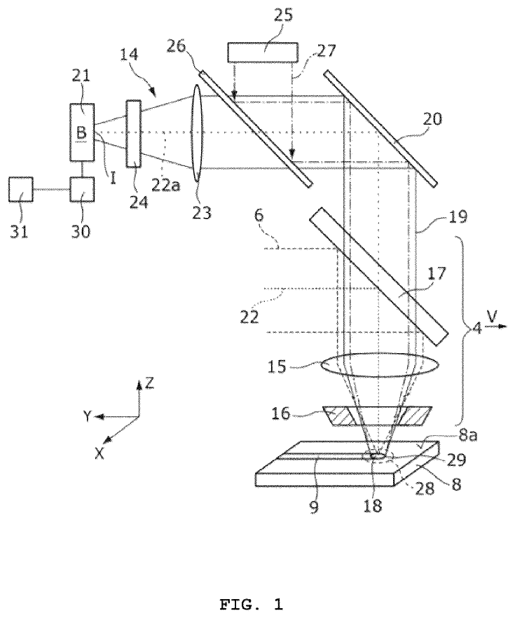

FIG. 1 shows an exemplary structure of a device 14 for process monitoring and process control of a laser machining method, in particular a laser cutting process, on a workpiece 8 by means of a laser machine tool 1, of which only the laser machining head 4 with a focusing lens 15 for focusing a laser beam 6 of the laser machine tool 1, a cutting gas nozzle 16, and a deflection mirror 17 are shown very schematically. Further components can be included in the laser machining head 4. In the present case, the deflecting mirror 17 has a partially transparent design and forms an entrance-side component for the process monitoring equipment 14. The laser beam 6 has a high power for machining the workpiece 8, in particular for cutting or separating the workpiece 8.

The deflection mirror 17 reflects the incident laser beam 6, which has, for example, a wavelength of approximately 10 μm or 1 μm in the case of a solid-state laser used, and transmits radiation relevant for process monitoring, reflected from the workpiece 8 and emitted from an interaction region 18 of the laser beam 6 with the workpiece 8, process radiation 19, in a wavelength range which in the present example lies between approximately 300 nm and 2000 nm. As an alternative to the partially transparent deflecting mirror 17, a scraper mirror or an aperture mirror can also be used to supply the process radiation 19 to the equipment 21.

In the device 14, another deflecting mirror 20 is arranged downstream of the partially transparent mirror 17 in the direction of the process radiation 19, and deflects the process radiation 19 to a geometrically highly resolving camera 21 as an image capturing unit. The camera 21 can be a high-speed camera which is arranged to be coaxial with the laser beam axis 22 or the extension of the laser beam axis 22a, and consequently is arranged in a directionally independent manner. In principle, it is also possible for the camera 21 to record the image using the reflected light method between about 300 nm and 2000 nm, provided that an additional illumination source is provided in this wavelength range, as well as alternatively the recording of the process self-illumination or process radiation 19 in the UV and NIR/IR wavelength ranges. The camera 21 can also be provided as the only image detection unit, so that no additional scanning beam is necessary. In both cases, the camera 21 detects the process radiation 19 or the process light from the interaction region 18.

In the present example, an imaging, focusing optical system 23 is provided between the partially transparent mirror 17 and the camera 21, which is shown as a lens in FIG. 1, which focuses the radiation or process radiation 19 relevant for process monitoring onto the camera 21. In the example shown in FIG. 1, a filter 24 in the direction of the process radiation 19 in front of the camera 21 is advantageous if further radiation components or wavelength components are to be excluded from detection with camera 21. The filter 24 can, for example, be in the form of a narrow bandwidth band pass filter.

In the present example, the camera 21 is optionally operated using the reflected light method, i.e., an additional illumination source 25 is provided above workpiece 8, which couples illumination radiation 27 to be coaxial to the laser beam axis 22 into the optical path via another partially transparent mirror 26. In principle, however, the intensity of the process radiation 19 generated during laser machining is sufficient. The respective beam paths are coaxial in the vertical direction as shown in FIG. 1. Laser diodes or diode lasers can be provided as an additional illumination source 25 which can be arranged to be coaxial, as shown in FIG. 1, or else off-axis in relation to the laser beam axis 22. The additional illumination source 25 can, for example, also be arranged outside, in particular adjacent to the laser machining head 4 and directed onto a surface 8a of the workpiece 8. Alternatively, the illumination source 25 can be arranged within the laser machining head 4. It is understood that the device 14 can also be operated without an additional illumination source 25.

In the example shown in FIG. 1, during a laser fusion cutting process or laser flame cutting process, camera 21 takes an image B of a region 28 of workpiece 8 to be monitored, which contains the interaction area 18. During the cutting process by the laser beam 6, a relative movement takes place between the workpiece 8 and the laser processing head 4 by the movement of the laser processing head 4 along the positive Y-direction (cf. arrow) with the relative velocity designated as feed speed V. The laser machining head 4 is also moved within the two planes in x-direction and z-direction. During the cutting process, a cutting front 29 is formed in the run-up to the interaction region 18, which is followed by a kerf 9 in workpiece 8 in the trail, in the negative Y-direction.

The image acquisition unit designed as a camera 21 is in signal-technical connection with an evaluation device 30. The evaluation device 30 is configured or programmed to recognize at least one disturbance in the machining process, such as a section break, on the basis of the evaluation of the recorded image B or a chronological sequence of images B of the area 28. The camera 21 and the evaluation device 30 form a sensor device.

The evaluation device 30 evaluates image B or a series of images B from interaction region 18 recorded one after the other to extract or identify features of interaction region 18 that indicate a disturbance in the cutting process.

As can be seen in FIG. 1, the evaluation device 30 is in signaling connection with an open-loop or closed-loop control device 31, with which the laser cutting process and the laser processing process are controlled in an open-loop or closed-loop manner.

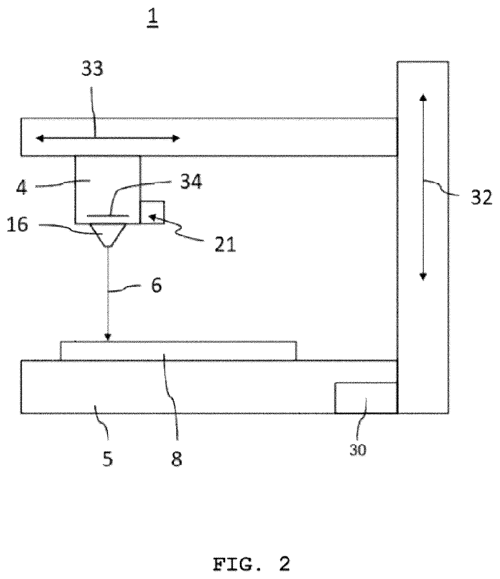

FIG. 2 shows a side view of a highly schematically illustrated laser machine tool 1. To monitor a laser machining method, in particular a laser cutting process, the camera 21 and the connected evaluation device 30 are included, similar to FIG. 1. Here the laser machine tool 1 is a laser cutting system. The workpiece 8, here a sheet metal, lies on the workpiece support 5 of the laser machine tool 1. The laser machine tool 1 has the laser machining head 4, which is a cutting head. The laser machining head 4 can be moved along a first translational axis 32, a second translational axis 33, and along an axis in the image plane relative to the workpiece support 5. Furthermore, the laser machining head 4 can be rotatable about one or more rotary axes in a manner not shown in detail.

For machining, for example cutting the workpiece 8, the laser machining head 4 or cutting head emits the laser beam 6. By means of the laser beam 6, the workpiece 8 is cut along a trajectory. To support the machining of the workpiece 8 with the laser beam 6, the laser machining head 4 has the cutting gas nozzle 16. A cutting gas is supplied to the workpiece 8 through the cutting gas nozzle 16. The laser machining head 4 can further comprise a protective glass 34 for a lens system not shown in detail in FIG. 2.

The laser machine tool 1 has the evaluation device 30 similar to FIG. 1, furthermore the control device 31 can be connected to the evaluation device 30 in terms of signal technology. The evaluation device 30 and the associated control device 31 carry out the cutting process by specifying and adjusting various process parameters or process variables F, K. Two of the process parameters can be, for example, a feed rate v and a focus position e, i.e., the position of the focus of the laser beam 6 relative to the workpiece 8. Further process parameters or process variables can be a laser power, a focus diameter, a gas pressure of the cutting gas before exiting the cutting gas nozzle 16, a mass flow or the composition of the cutting gas through the cutting gas nozzle 16 and/or a distance of the cutting gas nozzle 16 from the workpiece 8.

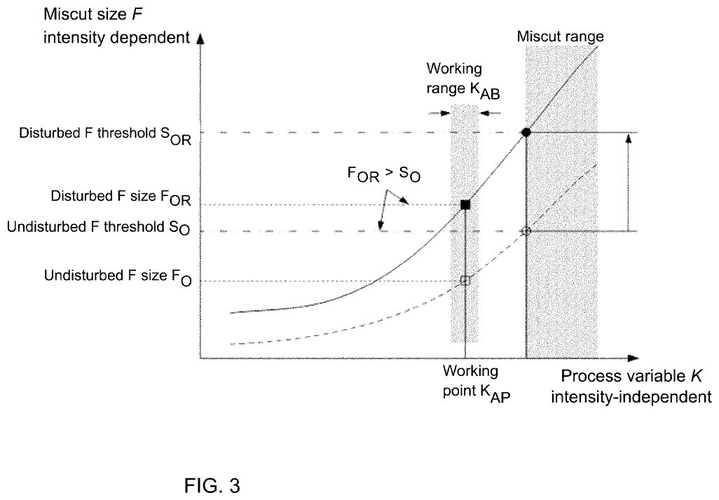

FIG. 3 shows a qualitative diagram for explaining an example of the invention. It was recognized that under normal machining conditions, light-intensity-dependent or intensity-dependent process variables can be used to easily distinguish between a miscut and a good cut under normal machining conditions. The process variables depend to varying degrees on the light intensity detected by the camera 21 and the sensor device used. For example, the gray value of a camera pixel is proportional to the light intensity, while a geometric variable in the camera image is independent of the light intensity. Nevertheless, geometric variables can also correlate with the light intensity, for example when threshold values are used for gray values of the camera images.

Under disturbed or difficult machining conditions, the intensity-dependent variables alone can no longer reliably determine malfunctions or disturbances in the machining process. Difficult machining conditions can occur, for example, if the light intensity of the scanning beam or the process radiation 19 is disturbed. Therefore, a second variable is introduced which is independent of the light intensity or less dependent on the light intensity. With the help of the second variable or process variable, malfunctions or disturbances in the machining process can be detected and thus the susceptibility to disturbances of the laser machining process is reduced.

An intensity-independent or sufficiently intensity-independent second process variable K is shown on the x-axis, approximately the trailing length, which indicates the distance in the feed direction from the cutting front 29 on the top to the cutting front 29 on the bottom of the workpiece 8. Another intensity-independent process variable K is the inclination angle of a cutting front 29, the angle between the top and the bottom of the workpiece 8 at the cut surface. These process variables K have proven to be suitable for functionality. On the y-axis is a first process variable F, in this example an intensity-dependent miscut variable F, with threshold values S₀ and S_{oR} in which a cut break is detected in the evaluation device 30 after exceeding the threshold values S₀ and S_{oR} due to the miscut variable F. Below the threshold values S_{O} or S_{oR}, i.e., if F<S_{O} or F<S_{0R}, a good cut is present. Above the threshold values S_{O} or S_{oR}, i.e., if F>S_{O} or F>S_{oR}, there is a miscut. The condition F<S_{O} applies to the non-updated threshold value in undisturbed operation if the threshold value is not changed, and the condition F>S_{oR} applies to the updated threshold value in faulty operation if the threshold value is changed. Optionally, the above conditions can be used to detect whether the cut is good or bad if the above conditions are met over a certain period of time. The threshold values S_{O} and S_{oR} are each located on characteristic curves at the boundary of a defined miscut region, which is shown as hatched in FIG. 3. In general, an updated threshold value S_{oR} is a function of the set threshold value S₀, the first process variable F, here miscut variable F, and the process variable K, where S_{oR}=f (F, K, S_{O}). In particular, the threshold value S_{O} is changed to the threshold value S_{oR} if the second process variable K at the working point K_{AP} or in a working range K_{AB} is located near the working point K_{AP}. Several working ranges K_{AB} can also be determined. The working range K_{AB} or the working ranges K_{AB} can assume any extent, i.e., along the x-axis in FIG. 3, denoted by the second process variable K, can range from a minimally measurable process variable K up to the hatched miscut region. The control device or regulating device 31 can, for example, carry out a process stop of the laser machine tool 1 when a miscut is detected.

For example, the control device 31 detects when the machining process deviates from the defined working point K_{AP}. The control device 31 can then guide the machining process back towards the defined working point by controlling process parameters or process variables. K_{AP} lead.

The diagram also shows the two characteristic curves of the laser machine tool 1 during operation, which show the course of the first process variable F or miscut variable F related to the second process variable K where the dashed curve indicates laser machining without disturbances or malfunctions and the solid curve indicates laser machining with disturbances or malfunctions, as described below. In the diagram in FIG. 3 the working point K_{AP} and a region along the process variable K are registered around the working point K_{AP}, the working range K_{AB}. The measuring range of the laser machine tool 1 and the laser machining process is preferably at the working point K_{AP} or the working point K_{AP} in the working range K_{AB}. In the laser machining process, the second process variable in the undisturbed process according to FIG. 3 is K during operation of the laser machine tool 1 in a working range K_{AB} and especially in the controlled operation of the process variable K at the defined working point K_{AP}. A working point K_{AP} defined this, where for the process variable K=K_{AP} is applicable and/or a working range K_{AB}, where the process variable K lies within a region around the working point K_{AP}. The undisturbed miscut variable F₀ on the dashed characteristic curve indicates an undisturbed operation of the laser machine tool 1, in which the evaluation device 30 does not detect any malfunction. At the working point K_{AP}, a threshold value S₀ which indicates a malfunction of the laser machine tool 1, a threshold of the undisturbed miscut variable, is designated in FIG. 3 as undisturbed F-threshold S₀. The threshold value S₀ is determined before operation of the laser machine tool 1, or alternatively during operation. If the miscut variable F exceeds the threshold value S₀ during laser machining, a malfunction is detected and a cut break is recognized. Optionally, the cut break is detected if the threshold value S₀ is exceeded for a certain period of time. The malfunction can be reliably detected without any process changes to the laser machine tool 1.

If process changes occur during operation of the laser machine tool 1, for example due to soiling on the focusing lens 15, the first process variable F or miscut variable F changes, which is recognized by the evaluation device 30. Process changes or disturbances lead to a shift in the characteristic curve in FIG. 3. For example, the light intensity of the first process variable F, the miscut variable F, changes when the laser beam 6 is disturbed by contamination, so that the camera 21 detects more process lights or process radiation 19 due to scattered radiation. A changed first process variable F or in the working range K_{AB}, especially at the working point K_{AP}, leads to a cut break being incorrectly detected. This changed first process variable is shown in FIG. 3 as perturbed F-variable F_{0R}, i.e., disturbed miscut variable. This false detection is shown in FIG. 3 as an indication that F_{0R}>S₀. The process changes lead to the first process variable F being shifted relative to the second process variable K. The characteristic curve as a functional relationship between the first process variable F and the second process variable K is shifted. In FIG. 3 the disturbed miscut variable F is shown as a solid characteristic curve. Without further measures, if the disturbed miscut variable F_{0R} is located in the working range K_{AB}, and especially at the working point K_{AP} above the threshold value S₀, i.e., F_{0R}>S₀ in FIG. 3, a cut break was falsely detected. To remedy this, a change in the first process variable F_{0R} is determined in the working range K_{AB}, and especially in the working point K_{AP}, which has a deviation from the undisturbed detected values for the first process variable F₀. If the machining process takes place in the working range K_{AB}, and especially at the working point K_{AP}, a threshold value S_{OR} is determined, above which a cut break is recognized as a malfunction, F_{0R}>S_{OR}. This newly set threshold value S_{OR}, designated in FIG. 3 as disturbed F-threshold S_{OR}, is at a larger value, such as a higher detected light intensity of the process radiation 19. For example, the threshold value S₀ can be changed to the threshold value S_{0R} proportional to the detected miscut variable F_{0R} according to the functional context S_{OR}=p*(F_{0R}/F₀) with a proportionality factor p. If the miscut variable F changes by about 20%, i.e., (F_{0R}/F₀)=1.2=p, the threshold value S₀ increases by 20% to the threshold value S_{0R}. If the miscut variable moves during operation, here with a disturbing influence on the disturbed miscut variable F_{0R}, above a threshold value S₀, the evaluation device 30 falsely detects a malfunction. After moving or resetting the threshold value S₀ to a threshold value S_{0R}, a malfunction is only recognized at a higher first process variable F or miscut variable F, whereby this corresponds to the actual conditions of the laser machine tool 1 during operation. Adjusting or changing the threshold value S₀ is carried out continuously during operation of the laser machine tool 1. Accordingly, the modified threshold value S_{0R} is then used to detect a cut break instead of the original threshold value S₀, which is changed accordingly to another threshold value of the process variable F₀, whereby the threshold value S_{0R} can be changed continuously. In particular, the threshold value S_{0R} of the first light-intensity-dependent process variable F can be continuously changed in a control process.

The functionality of the described laser machine tool 1 and the laser machining method is further illustrated with a hatched miscut region in FIG. 3. The miscut region represents the region in the diagram of the second process variable K in which the evaluation device 30 detects a cut break. The hatched miscut region is defined as a rectangular region for example, but can take any shape in the diagram. In the hatched characteristic curve during undisturbed operation, the detected cutting break is at the threshold of the undisturbed miscut variable S₀. In the case of the solid characteristic curve during disturbed operation, as described, the detected cutting break is at the threshold of the miscut variable S_{0R}, which has a higher value of the intensity-dependent first process variable F has.

Determining the first process variable F can also be carried out in the known working range K_{AB} if the working point K_{AP} is not reached in uncontrolled operation and the profile shape of the first process variable is known as a miscut variable F according to the characteristic curves in FIG. 3 in the corresponding range. Ideally, the second process variable K is regulated at the working point K_{AP} to minimize the working range K_{AB}.

In another example, a control setpoint R of the laser machining process is assigned to the threshold value S₀ and the control setpoint R is changed to a control setpoint R_{OR} according to the change of the first process variable F from a value F₀ to a value F_{0R}. If the evaluation device 30 detects a change in the first process variable F at the working point K_{AP} or in the working range K_{AB}, for example an increased light intensity due to a disturbance of the optical system 23, this increased light intensity would be incorrectly attributed to a changed trailing length. With the control setpoint R the laser machine tool 1 would undesirably change the speed of the feed of the workpiece 8 with the increased trailing length. The correct trailing length is determined using the light-intensity-independent process variable K at the working point K_{AP} or in the working range K_{AB}. To ensure that the control of the speed of the feed rate of the workpiece 8 continues to be carried out reliably, the control setpoint R is changed to the control setpoint R_{OR} in the evaluation device 30 so that the speed of the feed of the workpiece 8 remains unchanged regardless of the change of the first process variable F. This feature prevents the control process from being disturbed by incorrect light-intensity-dependent measurements of the first process variable F. In other words, the second process variable K corrects incorrect measurements of the first process variable F with reference to the control of the laser machine tool 1, by adjusting the control setpoint R_{OR}. With adjustments to the control setpoint R_{OR}, the first process variable F can also continue to be used reliably despite a malfunction of the optical system 23. This avoids subsequent calibration of the first process variable F, which is necessary without the measures described. Therefore, the principle of changing the control setpoint R corresponds to the principle of changing the threshold value at which a cut break is detected.

The described method for laser machining is also applicable to other technical fields and is not limited to the technical field of laser machine tools 1. The described method is applicable in all technical areas in which process variables change and threshold values are adjusted, changed, or controlled automatically and without recalibration.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

LIST OF REFERENCE SYMBOLS

| | |
|---|---|
| 1 | Laser machine tool |
| 4 | Laser machining head |
| 5 | Workpiece rest |
| 6 | Laser beam |
| 8 | Workpiece |
| 8a | Surface |
| 9 | Kerf |
| 10 | Cutting gas |
| 14 | Device |
| 15 | Focusing lens |
| 16 | Cutting gas nozzle |
| 17 | Deflection mirror |
| 18 | Interaction region |
| 19 | Process radiation |
| 20 | Additional deflection mirror |
| 21 | Camera |
| 22 | Laser beam axis |
| 22a | Scanning beam axis |
| 23 | Optical system |
| 24 | Filter |
| 25 | Lighting source |
| 26 | Partially transparent mirror |
| 27 | Illumination radiation |
| 28 | Region to be monitored |
| 29 | Cutting front |
| 30 | Evaluation unit |
| 31 | Control device |
| 32 | First translational axis |
| 33 | Second translational axis |
| 34 | Protective glass |

1. A laser machining method, comprising:
defining at least one threshold value S₀ with respect to a light-intensity-dependent first process variable F in at least one working range K_{AB} or at a working point K_{AP};
detecting a light-intensity-independent second process variable K during operation of a laser machine tool in the at least one working range K_{AB} or at the working point K_{AP};
determining a change in the first process variable F in the at least one working range K_{AB} or at the working point K_{AP} when process conditions change; and
changing the at least one threshold value S₀ to a second threshold value S_{0R} according to the change of the first process variable F from a first value F₀ to a second value F_{0R}.

2. The laser machining method according to claim 1, further comprising:
assigning a control setpoint R of the laser machining process to the threshold value S₀;
changing the control setpoint R to a second control setpoint R_{OR} according to the change of the first process variable F from the first value F₀ to the value F_{0R}.

3. The laser machining method according to claim 1, further comprising:
controlling the second process variable K as a trailing length or an inclination angle of a cutting front on a workpiece to be cut.

4. The laser machining method according to claim 1, wherein:
the changing the at least one threshold value S₀ to the second threshold value S_{0R} at the working point K_{AP} or in the at least one working range K_{AB} is performed according to a recorded light intensity on a workpiece as the first process variable F.

5. The laser machining method according to claim 1, further comprising:
determining a malfunction of the laser machine tool based on the second threshold value S_{0R}.

6. The laser machining method according to claim 5, wherein:
the determining the malfunction comprises determining a cut break based on the changed threshold value S_{0R}.

7. The laser machining method according to claim 1, wherein:
the changing the at least one threshold value S₀ comprises proportionally changing the at least one threshold value S₀ to the second threshold value S_{0R} according to the change of the first process variable F.

8. The laser machining method according to claim 1, further comprising:
controlling the second process variable K as a control variable with an adjustable variable of a feed speed of a workpiece in the laser machine tool or the power supply of the laser machine tool.

9. The laser machining method according to claim 1, wherein the change in the first process variable F is detected in a location-dependent, time-dependent, and/or direction-dependent manner, and the at least one threshold value S₀ is changed or set in a location-dependent, time-dependent and/or direction-dependent manner.

10. A laser machine tool comprising an evaluation device, wherein the evaluation device is configured to:
define at least one threshold value S₀ with respect to a light-intensity-dependent first process variable F in at least one working range K_{AB} or at a working point K_{AP},
detect a light-intensity-independent second process variable K during operation of the laser machine tool in a working range K_{AB} or at a working point K_{AP},
determine a change in the first process variable F in the at least one working range K_{AB} or at the working point K_{AP} in an event of changed process conditions, and
change the at least one threshold value S₀ to a second threshold value S_{0R} according to the change of the first process variable F from a first value F₀ to a second value F_{0R}.

11. The laser machine tool according to claim 10, wherein the evaluation device is further configured to control a trailing length or an angle of inclination of a cutting front on a workpiece to be cut as the second process variable K.

12. The laser machine tool according to claim 10, wherein the changing the at least one threshold value S₀ to the second threshold value S_{0R} at the working point K_{AP} is performed according to a recorded light intensity in the working range K_{AB} of a workpiece as the first process variable F.

13. The laser machine tool having an evaluation device according to claim 10, wherein the evaluation device is further configured to detect a malfunction of the laser machine tool based on the second threshold value S_{0R}.

14. The laser machine tool having an evaluation device according to claim 10, wherein the changing the at least one threshold value S₀ comprises proportionally changing the at least one threshold value S₀ to the second threshold value S_{0R} according to the change of the first process variable F.

15. A non-transitory computer-readable medium having program steps stored thereon, the program steps, when executed by a computer processor in an evaluation device, causing performance of a method according to claim 1.
